(19) United States
(12) Patent Application Publication
(10) Pub. No.: US 2017/0363292 A1
(43) Pub. Date: Dec. 21, 2017

(54) METHOD OF ACCESSING A NOZZLE TIP ASSEMBLY OF A FUEL NOZZLE

(71) Applicant: Pratt & Whitney Canada Corp., Longueuil (CA)

(72) Inventors: OLEG MORENKO, OAKVILLE (CA); BHAWAN BHAI PATEL, MISSISSAUGA (CA); JEAN-FRANCOIS GRENIER, VARENNES (CA)

(21) Appl. No.: 15/185,308

(22) Filed: Jun. 17, 2016

(51) Int. Cl. F23R 3/28; B23P 6/00; F02C 7/22; F02C 7/24

(52) U.S. Cl. CPC F23R 3/283; F02C 7/24; B23P 6/002; F02C 7/222; F05D 2220/32

(57) ABSTRACT

A method of accessing a nozzle tip assembly of a gas turbine engine fuel nozzle is disclosed. The fuel nozzle has a stem and a heat shield enclosing at least part of the stem. The nozzle tip assembly is disposed within an inner cavity of the stem. The method includes forming an opening in at least the heat shield of the fuel nozzle, the opening providing access to the inner cavity of the stem via a first end thereof. The first end of the cavity is positioned opposite to a fuel nozzle exit from which fuel is conveyed from the fuel nozzle. The method includes accessing the nozzle tip assembly in the inner cavity via the opening. The method includes closing the opening after accessing the nozzle tip assembly.

### TECHNICAL FIELD

The application relates generally to gas turbine engines, and more particularly to fuel nozzles for combustors of gas turbine engine

### BACKGROUND

Gas turbine engine fuel nozzles which use a pressure atomizing nozzle tip, for providing the combustor with a pressurized spray of fuel and air, are known. The components that make up the nozzle tip are typically placed within a cavity in the stem of the fuel nozzle. It is often difficult or impossible to access the components of the nozzle tip within the cavity once the fuel nozzle has been assembled, which makes it difficult to perform repairs. This results in relatively new fuel nozzles or their components being scrapped prematurely.

### SUMMARY

There is accordingly provided a method of accessing a nozzle tip assembly of a gas turbine engine fuel nozzle, the fuel nozzle having a stem and a heat shield enclosing at least part of the stem, the nozzle tip assembly being disposed within an inner cavity of the stem, a first end of the cavity being positioned opposite to a fuel nozzle exit from which fuel is sprayed from the fuel nozzle, the method comprising: forming an opening in at least the heat shield of the fuel nozzle, the opening providing access to the inner cavity of the stem via the first end thereof; accessing the nozzle tip assembly in the inner cavity via the opening; and closing the opening after accessing the nozzle tip assembly.

There is also provided a method of accessing a nozzle tip assembly of a gas turbine engine fuel nozzle, the fuel nozzle having a stem and a heat shield enclosing at least part of the stem, the nozzle tip assembly being disposed within an inner cavity of the stem, a first end of the cavity being positioned opposite to a fuel nozzle exit from which fuel is sprayed from the fuel nozzle, the method comprising: machining an opening through the heat shield and through the stem of the fuel nozzle, the opening providing access to the inner cavity of the stem via the first end thereof; accessing the nozzle tip assembly in the inner cavity via the opening; and closing the opening after accessing the nozzle tip assembly.

There is further provided a method of accessing a nozzle tip assembly of a gas turbine engine fuel nozzle, the fuel nozzle having a stem and a heat shield enclosing at least part of the stem, the nozzle tip assembly being disposed within an inner cavity of the stem, a first end of the cavity being positioned opposite to a fuel nozzle exit from which fuel is sprayed from the fuel nozzle, the method comprising: machining an opening through the heat shield and through the stem of the fuel nozzle, the opening providing access to the inner cavity of the stem via the first end thereof; accessing the nozzle tip assembly in the inner cavity via the opening; and covering the opening after accessing the nozzle tip assembly with a portion of the heat shield.

There may be alternately provided a fuel nozzle for a combustor of a gas turbine engine, comprising: a fuel nozzle stem extending between a nozzle head and an opposed nozzle tip; a nozzle sheath at least partially surrounding the stem, the nozzle sheath having a heat shield at least partially enclosing the nozzle tip, a portion of the heat shield being machinable to form an opening in the heat shield; and the nozzle tip having an inner nozzle tip assembly, the inner nozzle tip assembly being accessible via the opening in the heat shield.

There may be alternately provided a fuel nozzle for a combustor of a gas turbine engine, comprising: a fuel nozzle stem extending between a nozzle head and an opposed nozzle tip, the stem having an elongated inner cavity extending through a portion of the nozzle tip, the inner cavity extending between an open downstream end and an open upstream end; a nozzle sheath at least partially surrounding the stem, the nozzle sheath having a heat shield at least partially enclosing the nozzle tip and covering the inner cavity at the upstream end thereof, a portion of the heat shield adjacent to the upstream end of the inner cavity being machinable to form an opening in the heat shield providing access to the inner cavity via the upstream end thereof; and an atomizing nozzle tip having an inner nozzle tip assembly disposed within the inner cavity, and an outer nozzle tip assembly at least partially surrounding the inner nozzle tip assembly, the inner nozzle tip assembly within the inner cavity being accessible via the opening in the heat shield.

### BRIEF DESCRIPTION OF THE DRAWINGS

Reference is now made to the accompanying figures in which:

FIG. 1 is a schematic cross-sectional view of a gas turbine engine;

FIG. 2A is a perspective view of a fuel nozzle and mounting support, according to an embodiment of the present disclosure;

FIG. 2B is a cross-sectional view of the fuel nozzle of FIG. 2A, taken along the line II-II of FIG. 2A; and

FIG. 3 is an enlarged, fragmentary cross-sectional view of the circled portion 3 in of FIG. 2B;

FIG. 4A is an enlarged, fragmentary side cross-sectional view of the circled portion 3 in of FIG. 2B;

FIG. 4B is another side cross-sectional view of the circled portion 3 in of FIG. 2B, a nozzle tip assembly being shown removed from an inner cavity of the fuel nozzle;

FIG. 4C is another side cross-sectional view of the circled portion 3 in of FIG. 2B, showing a new nozzle tip assembly;

FIG. 4D is another side cross-sectional view of the circled portion 3 in of FIG. 2B, the new nozzle tip assembly being shown within the inner cavity; and

FIG. 5 is an enlarged, fragmentary cross-sectional view of a nozzle tip of a fuel nozzle, according to another embodiment of the present disclosure.

### DETAILED DESCRIPTION

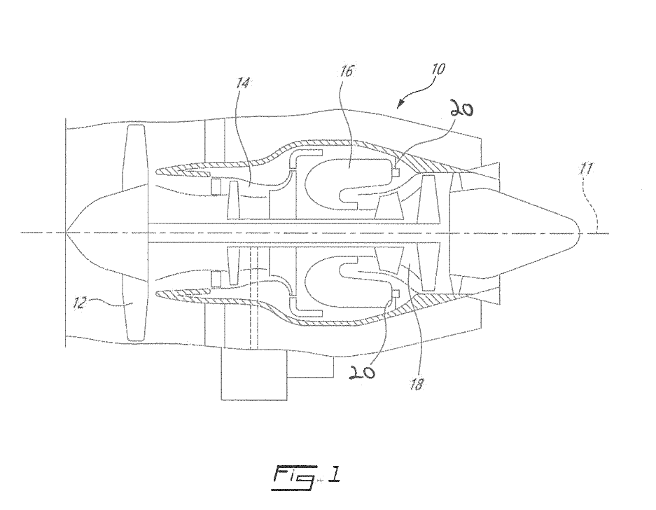

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The gas turbine engine 10 has one or more fuel nozzles 20 which supply the combustor 16 with fuel which is combusted with the air in order to generate the hot combustion gases.

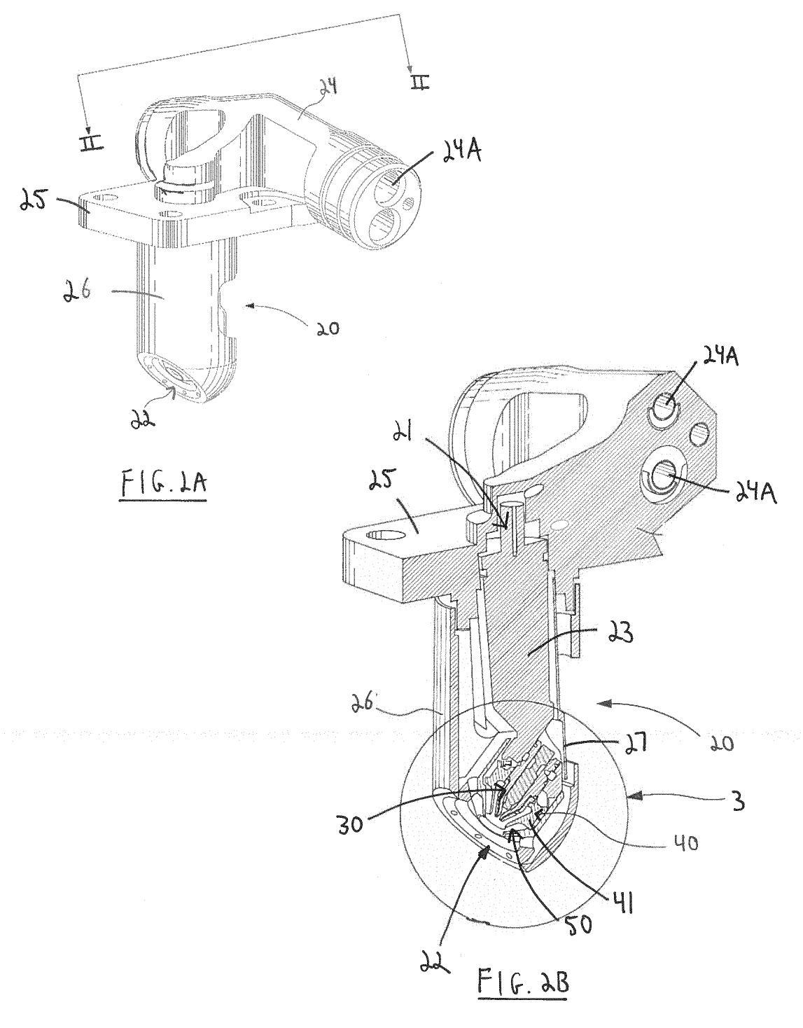

An example of one such fuel nozzle 20 (or simply “nozzle”) is provided in FIGS. 2A and 2B. In the depicted embodiment, the nozzle 20 typically has a nozzle head 24 located outside of a casing of the combustor, a nozzle tip 22 located within the casing, and a nozzle stem 23 connecting the head to the tip and providing fuel communication therebetween. The nozzle 20 atomizes a mixture of air and fuel to be combusted. The atomization of the fuel and air into finely dispersed particles occurs because the air and fuel are supplied to the fuel nozzle 20 under relatively high pressure, and mixed together within the nozzle tip 22. The nozzle 20 therefore outputs a fine and uniformly-distributed mist mixture of the air and fuel. In providing such a fine mist, the nozzle 20 helps to ensure a more efficient combustion of the mixture. Fuel is supplied to the nozzle 20 via a manifold head 24, and the nozzle 20 is secured to the engine via a mounting plate 25. The manifold head 24 has and one or more fuel inlets 24A which supply fuel to the nozzle 20.

In the depicted embodiment of FIG. 2B, the nozzle 20 has two nozzles within the same structure. One such nozzle is an inner fuel primary pressure atomizing nozzle tip assembly 30, and the other nozzle is an outer, airblast air atomizing nozzle tip assembly 40. Collectively, the nozzle tip assemblies 30, 40 form an atomizing nozzle tip 50. Both nozzle tip assemblies 30,40 are contained in an outer nozzle sheath 26 which forms the outer shell of the fuel nozzle 20 and encloses both the inner and outer nozzle tip assemblies 30,40. The nozzle sheath 26 directs air into the nozzle 20, diverts water and other foreign materials away from the air passages, and provides support to help hold the combustor in place. The nozzle 20 and/or nozzle sheath 26 has a heat shield 27. In the depicted embodiment, the heat shield 27 is not a part of the nozzle sheath 26, but it can be. The protective heat shield 27 shields and at least partially insulates the inner and outer nozzle tip assemblies 30, 40 at the nozzle tip 22 from the hot combustion gases generated in the combustor.

The inner, or “primary pressure”, nozzle tip assembly 30 generally receives and outputs only fuel. Although used throughout all operating modes of engine operation, it is particularly useful during engine start-up or ignition, and employs a drop in fuel pressure to atomize the fuel by reducing the size of the fuel droplets. The inner nozzle tip assembly 30 is therefore able to generate a very fine mist of fuel for a relatively small flow capacity, which is ideal for engine start-up. During normal engine operation, the inner nozzle tip assembly 30 is used with the outer nozzle tip assembly 40 to meet the operating needs of the engine. The inner nozzle tip assembly 30 can thus be referred to as a “starting” nozzle.

The outer nozzle tip assembly 40, in the depicted embodiment, provides the main airblast to the nozzle tip 22, and also provides addition fuel to complement that provided by the inner nozzle tip assembly 30 for optimal normal engine operation. The body 41 of the outer nozzle tip assembly 40 is disposed about the inner nozzle tip assembly 30 so as to surround and enclose it.

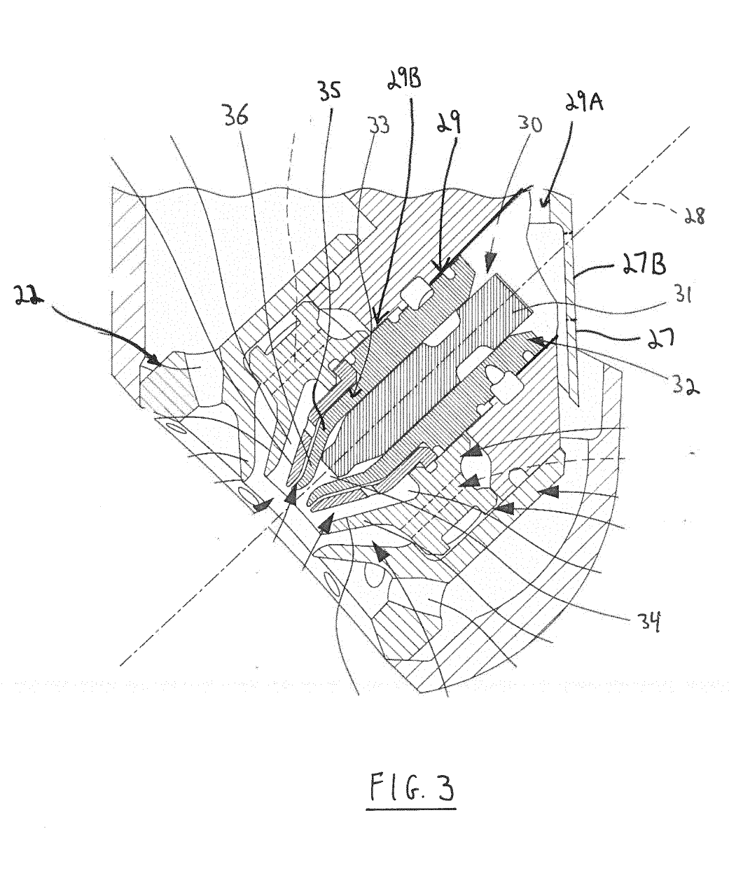

Referring to FIG. 3, the inner nozzle tip assembly 30 has a fuel distributor 31, which is generally an elongated annular body which is coaxial about the fuel nozzle center axis 28. It extends along a length between an upstream end 32 of the inner nozzle tip assembly 30 and a downstream end 33. The fuel distributor 31 receives a supply of fuel from an upstream supply in the fuel nozzle 20, increases the velocity of the fuel, and outputs via an outlet 34 as a fine spray. The inner nozzle tip assembly 30 generally has a convergent outer member 35 which encloses the fuel distributor 31, when present, and which is a hollow annular member being coaxial about the nozzle center axis 28. The outer member 35 has a convergent extremity 36 or cone at the downstream end 33 which channels the fuel from the fuel distributor 31 to a relatively small exit from the inner nozzle tip assembly 30.

The inner nozzle tip assembly 30 is located, at least partially, within an elongated inner cavity 29 in the stem 23. The inner cavity 29 provides a housing for the inner nozzle tip assembly 30 within the stem 23 so that the inner nozzle tip assembly 30 can be secured thereto. In the depicted embodiment, the inner cavity 29 is a through bore which forms an annular passage extending through the stem 23 at the nozzle tip 22. More particularly, the inner cavity 29 extends between a first and open upstream end 29A, and a second and open downstream end 29B. The terms “upstream” and “downstream”, when used to describe the ends 29A, 29B of the inner cavity 29, refer to the direction of fuel flow through the nozzle 20. Stated differently, the downstream end 29B of the inner cavity 29 is closer than the upstream end 29A to the outlet 34 of the inner nozzle tip assembly 30 from which the fuel is sprayed. In the depicted embodiment, the upstream end 29A can therefore be referred to as a “rear” end of the inner cavity 29. The open upstream end 29A is open, which allows the inner cavity 29 (and the inner nozzle tip assembly 30 disposed therein) to be accessed. As will be discussed in greater detail below, the inner cavity 29 can have different configurations, and may be closed at one of its ends 29A, 29B.

Whether open or closed, the upstream end 29A is covered and protected by a portion of the heat shield 27. Therefore, to access the inner nozzle tip assembly 30 via the upstream end 29A to repair or replace the inner nozzle tip assembly 30, access must be provided in the heat shield 27.

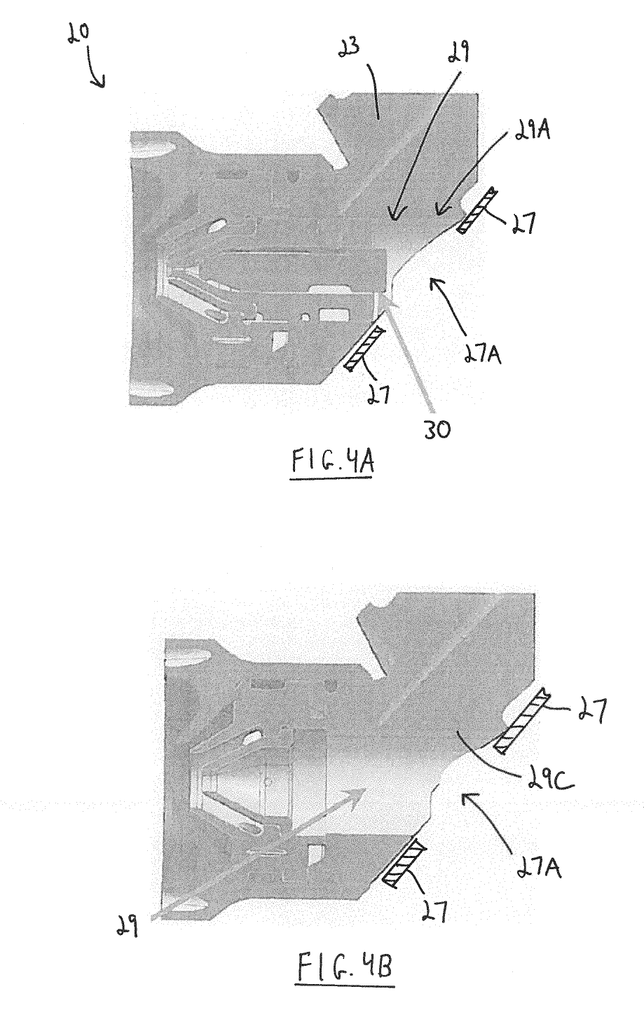

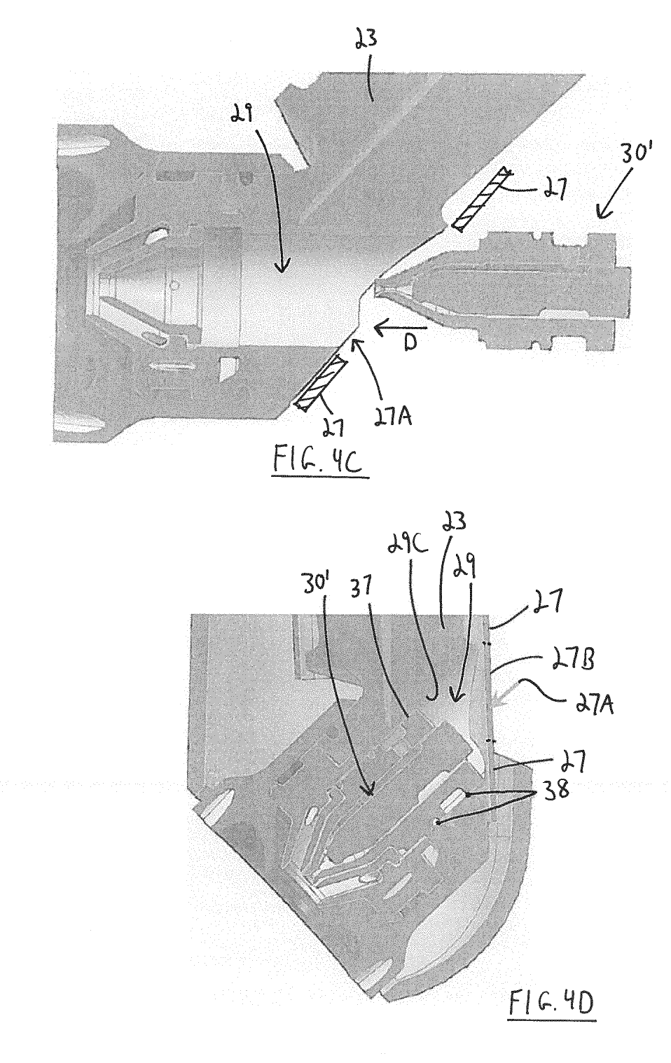

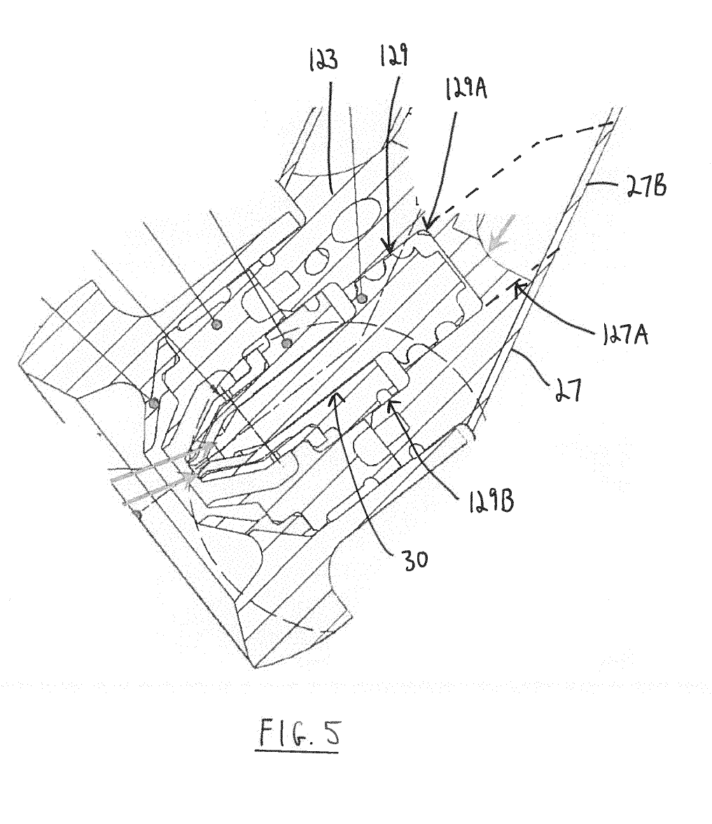

Referring to FIGS. 4A to 4D, a method of accessing at least the inner (primary) nozzle tip assembly 30 within the inner cavity 29 will now be described in greater detail. The method allows for a technician to access the inner nozzle tip assembly 30 within the inner cavity 29 without having to uninstall the entire nozzle 20 and/or nozzle tip 22. The technician may then repair or replace the nozzle tip assembly 30 and close off the access, thereby helping to extend the service life of the nozzle 20.

Referring to FIG. 4A, the method includes the step of forming an opening 27A in at least the heat shield 27 to access the inner cavity 29. The expression “at least” refers to the possibility that another opening may also be formed in other components of the nozzle 20, such as in the stem 23, or that the opening 27A can be extended through other components of the nozzle 20. One such embodiment is discussed in greater detail below. The opening 27A is of sufficient size and adequately shaped so that the technician can access the inner cavity 29 via the opening 27A to repair or replace the inner nozzle tip assembly 30. More particularly, the opening 27A in at least the heat shield 27 is adjacent to the upstream, or first, end 29A of the inner cavity 29. This allows the technician to access the inner nozzle tip assembly 30 via the opening 27A in the heat shield 27, and through the open “rear” upstream end 29A of the inner cavity 29.

The opening 27A in at least the heat shield 27 can be formed by any suitable technique. For example, the opening 27A can be machined. Some machining operations include drilling, grinding, reaming, and boring, and other machining operations using machining tools are also within the scope of the present disclosure. It will thus be appreciated that a portion 27B (see FIG. 3) of the heat shield 27 adjacent to the upstream end 29A of the inner cavity 29 is machinable. This machinable portion 27B allows the opening 27A in the heat shield 27 to be formed.

Referring to FIG. 4B, the method also includes accessing the inner nozzle tip assembly 30 (see FIG. 4A) in the inner cavity 29 via the opening 27A in at least the heat shield 27. As previously explained, the inner nozzle tip assembly 30 can be accessed to be repaired or replaced. An example of a repair operation that can be performed includes repairing brazed joints between the inner nozzle tip assembly 30 and an inner surface 29C of the inner cavity 29. Other repair operations are also possible. Some of these include removing carbon formation, accessing and inspecting external brazing joints/welds, and manipulating portions of the inner nozzle tip assembly 30 that may be deformed. It will thus be appreciated that the repair operations are more easily performed via the rear, or upstream end 29A of the inner cavity 29 than via the front or downstream end 29B as is done with some conventional techniques. This facilitates the repair process and helps to reduce the duration of servicing. Since repairs are made relatively easier to perform, they contribute to the service life of the nozzle 20 and help to reduce the number of inner nozzle tip assemblies 30 and/or nozzles 20 that are scrapped prematurely.

In the depicted embodiment of FIGS. 4B to 4D, accessing the inner nozzle tip assembly 30 includes replacing it. The inner nozzle tip assembly 30 is not shown in FIG. 4B because it has been removed. In an embodiment, the inner nozzle tip assembly is removed by inserting a machining tool into the inner cavity 29 via the opening 27A to destroy the inner nozzle tip assembly 30 therein. By “destroy”, it is understood that the inner nozzle tip assembly 30 mechanically demolished and put beyond use. This can be achieved, for example, by boring the inner nozzle tip assembly 30 out of the inner cavity 29. The fragmented pieces of the inner nozzle tip assembly 30 are then removed from the inner cavity 29 via the opening 27A in at least the heat shield 27. The result is a substantially empty inner cavity 29, as shown in FIG. 4B.

Referring to FIG. 4C, accessing the inner nozzle tip assembly 30 to replace it includes inserting a new nozzle tip assembly 30′ into the inner cavity 29 of the stem 23 via the opening 27A in at least the heat shield 27. The new nozzle tip assembly 30′ is inserted through the “rear” of the nozzle stem 30, via the opening 27A in at least the heat shield 27, along direction D. Prior to being inserted into the inner cavity 29, the components of the new inner nozzle tip assembly 30′ can be assembled, calibrated, and tested. This contributes to reducing the duration of servicing and installation because testing and calibration can be performed off-site.

Once inserted and properly positioned within the inner cavity 29, and as shown in FIG. 4D, an outer surface 37 of the new inner nozzle tip assembly 30′ is brazed to the inner surface 29C of the inner cavity 29 to attach the new inner nozzle tip assembly 30′ to the stem 23. Brazing forms brazing joints 38 between the inner surface 29C and the outer surface 37.

Once the inner nozzle tip assembly 30 has been repaired, inspected, or replaced, the method includes closing the opening 27A. In the depicted embodiment of FIG. 4D, closing the opening 27A includes covering the opening 27A with the machinable heat shield portion 27B and securing the portion 27B to the remainder of the heat shield 27 by any suitable technique. It will be appreciated that the heat shield portion 27B can be the same portion of the heat shield 27 that was removed to form the opening 27A, or may be a new piece of heat shield material.

As explained above, the configuration of the inner cavity 29 may vary from that described above. Referring to FIG. 5, the inner cavity 129 of the depicted embodiment extends between a closed upstream end 129A, and an open downstream end 129B. The open downstream end 129B allows the inner nozzle tip assembly 30 to be placed within the inner cavity 129, and the closed upstream end 129A prevents the inner nozzle tip assembly 30 from being conveyed through the “rear” of the stem 123. In order to access the inner cavity 129 of the depicted embodiment and the inner nozzle tip assembly 30 therein, the step of forming an opening 127A in at least the heat shield 27 also includes extending the opening 127A through the stem 123 adjacent to the upstream end 129A of the inner cavity 129. The extended opening 127A through the heat shield 27 and through the rear of the stem 123 provides access to the inner cavity 129 via its upstream end 129A. The extended opening 127A can be formed using any suitable machining tool. Therefore, the method disclosed herein helps to provide access to inner cavities 29,129 that have both open and closed upstream ends 29A, 129A.

The above description is meant to be exemplary only, and one skilled in the art will recognize that changes may be made to the embodiments described without departing from the scope of the invention disclosed. Still other modifications which fall within the scope of the appended claims will be apparent to those skilled in the art, in light of a review of this disclosure, and such modifications are intended to fall within the claims.

1. A method of accessing a nozzle tip assembly of a gas turbine engine fuel nozzle, the fuel nozzle having a stem and a heat shield enclosing at least part of the stem, the nozzle tip assembly being disposed within an inner cavity of the stem, a first end of the cavity being positioned opposite to a fuel nozzle exit from which fuel is sprayed from the fuel nozzle, the method comprising:
forming an opening in at least the heat shield of the fuel nozzle, the opening providing access to the inner cavity of the stem via the first end thereof;
accessing the nozzle tip assembly in the inner cavity via the opening; and
closing the opening after accessing the nozzle tip assembly.

2. The method of claim 1, wherein accessing the nozzle tip assembly includes repairing the nozzle tip assembly.

3. The method of claim 2, wherein repairing the nozzle tip assembly includes repairing brazed joints between the nozzle tip assembly and an inner surface of the inner cavity.

4. The method of claim 1, wherein accessing the nozzle tip assembly includes replacing the nozzle tip assembly.

5. The method of claim 1, wherein accessing the nozzle tip assembly includes inserting a machining tool into the inner cavity via the opening to destroy the nozzle tip assembly therein, and removing the destroyed nozzle tip assembly from the inner cavity via the opening.

6. The method of claim 5, wherein accessing the nozzle tip assembly includes inserting a new nozzle tip assembly into the inner cavity of the stem via the opening.

7. The method of claim 6, wherein inserting the new nozzle tip assembly includes brazing an outer surface of the new nozzle tip assembly to an inner surface of the inner cavity to attach the new nozzle tip assembly thereto.

8. The method of claim 6, wherein inserting the new nozzle tip assembly includes assembling and testing the new nozzle tip assembly prior to inserting the nozzle tip assembly.

9. The method of claim 1, wherein forming the opening includes extending the opening through the stem adjacent to the first end of the cavity, the extended opening providing access to the inner cavity of the stem via the first end thereof.

10. The method of claim 1, wherein closing the opening includes covering the opening with a heat shield portion.

11. The method of claim 1, wherein forming the opening includes machining the opening in at least the heat shield.

12. A method of accessing a nozzle tip assembly of a gas turbine engine fuel nozzle, the fuel nozzle having a stem and a heat shield enclosing at least part of the stem, the nozzle tip assembly being disposed within an inner cavity of the stem, a first end of the cavity being positioned opposite to a fuel nozzle exit from which fuel is sprayed from the fuel nozzle, the method comprising:
machining an opening through the heat shield and through the stem of the fuel nozzle, the opening providing access to the inner cavity of the stem via the first end thereof;
accessing the nozzle tip assembly in the inner cavity via the opening; and
closing the opening after accessing the nozzle tip assembly.

13. The method of claim 12, wherein accessing the nozzle tip assembly includes repairing the nozzle tip assembly.

14. The method of claim 12, wherein accessing the nozzle tip assembly includes replacing the nozzle tip assembly.

15. The method of claim 12, wherein accessing the nozzle tip assembly includes inserting a machining tool into the inner cavity via the opening to destroy the nozzle tip assembly therein, and removing the destroyed nozzle tip assembly from the inner cavity via the opening.

16. The method of claim 15, wherein accessing the nozzle tip assembly includes inserting a new nozzle tip assembly into the inner cavity of the stem via the opening.

17. The method of claim 12, wherein closing the opening includes covering the opening with a heat shield portion.

18. A method of accessing a nozzle tip assembly of a gas turbine engine fuel nozzle, the fuel nozzle having a stem and a heat shield enclosing at least part of the stem, the nozzle tip assembly being disposed within an inner cavity of the stem, a first end of the cavity being positioned opposite to a fuel nozzle exit from which fuel is sprayed from the fuel nozzle, the method comprising:
machining an opening through the heat shield and through the stem of the fuel nozzle, the opening providing access to the inner cavity of the stem via the first end thereof;
accessing the nozzle tip assembly in the inner cavity via the opening; and
covering the opening after accessing the nozzle tip assembly with a portion of the heat shield.

19. The method of claim 18, wherein accessing the nozzle tip assembly includes repairing the nozzle tip assembly.

20. The method of claim 18, wherein accessing the nozzle tip assembly includes replacing the nozzle tip assembly.
